(19) United States
(12) Patent Application Publication
(10) Pub. No.: US 2008/0155041 A1
(43) Pub. Date: Jun. 26, 2008

(54) Virtual environment for communication

(75) Inventor: Barry Patel, London (GB)

Correspondence Address: William L, Botjer, PO Box 478, Center Moriches, NY, 11934, US

(73) Assignee: Epulse Limited

(21) Appl. No.: 11/784,432

(22) Filed: Apr. 6, 2007

Related U.S. Application Data
(60) Provisional application No. 60/876,763, filed on Dec. 22, 2006.

(51) Int. Cl. G06F 15/16

(52) U.S. Cl. 709/206

(57) ABSTRACT

The present invention provides a method, a system and a computer program product for communication across a network of computational devices. The present invention makes use of a virtual environment module for communication. The virtual environment module is utilized by a first user to communicate with one or more groups of contacts, who are connected to the first user via the networks of data-processing units. The first user utilizes various functions present in the virtual environment module, to send information to or receive information from the one or more groups of contacts. Further, the first user can also select the one or more groups of contacts with whom he/she wishes to communicate.

### REFERENCE TO RELATED APPLICATIONS

This patent application claims priority from a U.S. Provisional Patent Application filed on Dec. 22, 2006 under Ser. No. 60/876,763.

### BACKGROUND

The invention described herein relates generally to communication over a network of data-processing units (DPUs), and more specifically, to communication using instant messengers over networks of DPUs.

Over-the-counter trading (OTC) comprises a set of transactions between two traders of financial instruments such as company-issued shares, bonds, derivatives and commodities. Examples of commodities include wheat, metals, crude oil, and the like. OTC trading refers to the trading of these financial instruments via a dealer network, instead of trading them in a centralized exchange.

OTC trading is generally carried out using auctions, where bids are placed by people. However, since the auctions take place at different locations, it is difficult for people to travel to each of the different locations. This becomes even more difficult when auctions take place simultaneously. The problems associated with widely dispersed auctions are solved by allowing auction bids to be placed by people who participate virtually in these auctions by using methods such as telephonic communication or communication software.

Communication software is usually used for a real-time text-based chat for OTC trading, and removes geographical constraints while enabling simultaneous real-time communication on a network of computational devices. Users apart from those performing OTC trading also face the problem of communicating with multiple contacts and groups of contacts who are widely dispersed geographically. Thus functionalities of the communication software are also required by users other than those performing OTC trading.

A communication software known in the art is the Akeni LAN messenger that supports conferencing between a user and the user's contacts, which enables personal messages to be sent to a plurality of contacts from a conferencing interface. Further, the Akeni LAN messenger also enables personal messages to be sent to individual contacts.

However, the communication software available today have one or more of the limitations mentioned below. The presence of multiple groups of contacts makes it difficult for a user to follow conversations with each of the multiple groups of contacts. Further, conversations between the user and individual contacts add to the difficulty in following conversations. In one or more available communication software, multiple conversations occupy separate window instances, which increase the complexity of the process for the user. These window instances do not allow the user to follow conversations with multiple groups of contacts in real-time. Difficulty in following conversations could result in misinterpretation and confusion. It is likely that a user is unable to communicate effectively by using the available communication software due to difficulty in following conversations.

In light of the above-mentioned limitations, a need exists for a method and system for clear and unambiguous communication between the user and the user's contacts for purposes including OTC trading. The method and system for clear and unambiguous communication would also need to be interoperable with existing chat platforms. Further, there is a need for a method and system for clear and unambiguous communication wherein, the communication between the user and a contact of the user is not accessible to other contacts of the user.

### SUMMARY OF THE INVENTION

An object of the present invention is to facilitate unambiguous communication of a user with multiple groups of contacts across a network of data-processing units (DPUs).

Another object of the present invention is to facilitate communication with multiple groups of contacts, in a single instance of a virtual environment module across a network of computational devices.

Another object of the present invention is to provide a method, a system and a computer program product for communication, wherein a first user communicates with each of one or more groups of contacts via separate communication channels.

The use of a single instance of the virtual environment module for communication with multiple groups of contacts would cause lowering of confusion for the first user. Also, the single instance of the virtual environment module for communication would enable the first user to follow the communications with each of the multiple groups of contacts in a more efficient manner, without having to shift from one window instance to another. Further, the use of separate communication channels prevents the communication between the user and a contact of the user from being accessible to other contacts of the user.

### BRIEF DESCRIPTION OF THE DRAWINGS

The preferred embodiments of the invention will hereinafter be described in conjunction with the appended drawings, provided to illustrate and not to limit the invention, wherein like designations denote like elements, and in which:

FIG. 1 illustrates an environment in which various embodiments of the present invention can be practiced;

FIG. 2 illustrates a block diagram of the elements of a virtual environment module functioning within a Data Processing Unit (DPU), according to an embodiment of the present invention;

FIG. 3 illustrates a block diagram of the elements of the virtual environment module functioning within a DPU, according to another embodiment of the present invention;

FIG. 4 illustrates an interface provided by a display module included in the virtual environment module, according to an embodiment of the present invention;

FIG. 5 illustrates a method for communication, according to an embodiment of the present invention;

FIG. 6 illustrates a method for communication, according to another embodiment of the present invention;

FIG. 7 illustrates a method for communication, according to yet another embodiment of the present invention;

FIG. 8 illustrates a first stage of communication, according to an embodiment of the invention;

FIG. 9 illustrates a second stage of communication, according to the embodiment of the invention;

FIG. 10 illustrates a third stage of communication, according to the embodiment of the invention;

FIG. 11 illustrates a fourth stage of communication, according to the embodiment of the invention;

FIG. 12 illustrates a fifth stage of communication, according to the embodiment of the invention; and

FIG. 13 illustrates a sixth stage of communication, according to the embodiment of the invention.

### DESCRIPTION OF THE INVENTION

Various embodiments of the present invention will now be explained with reference to the figures attached.

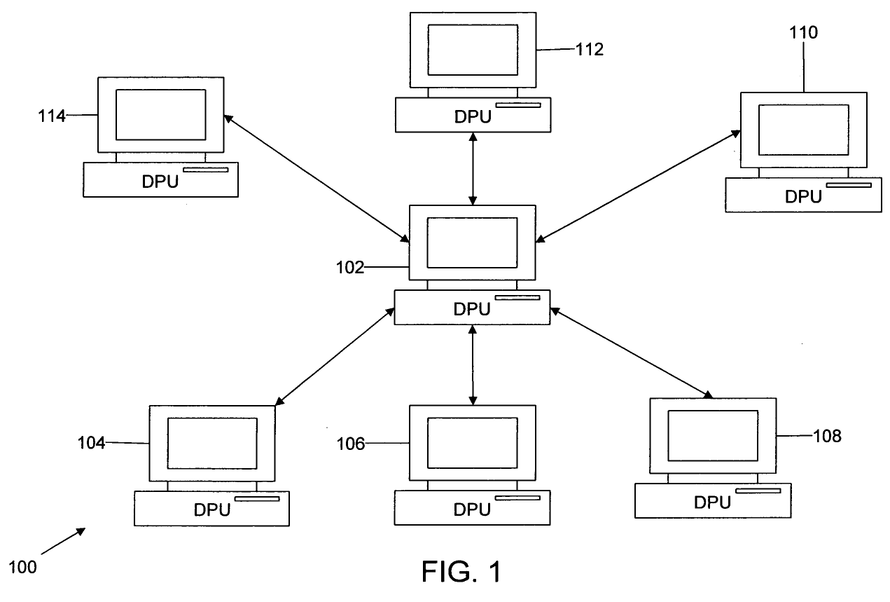

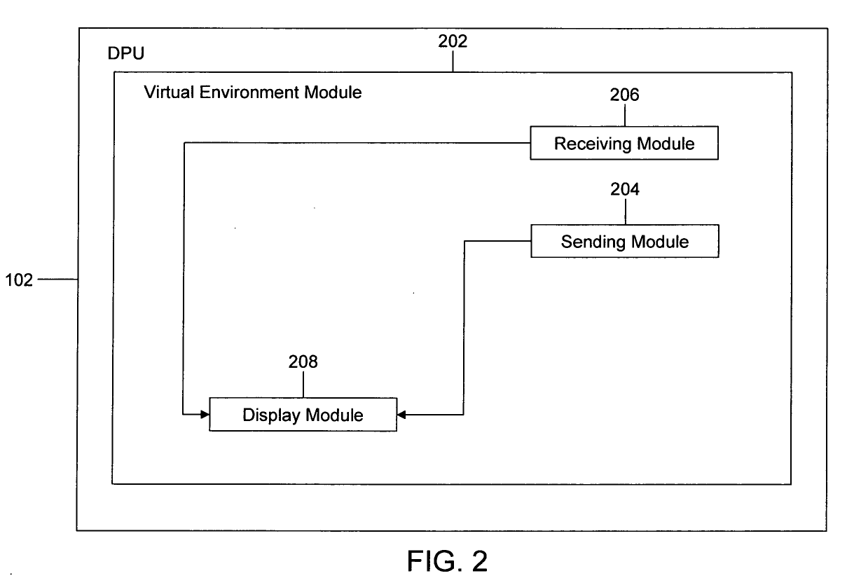

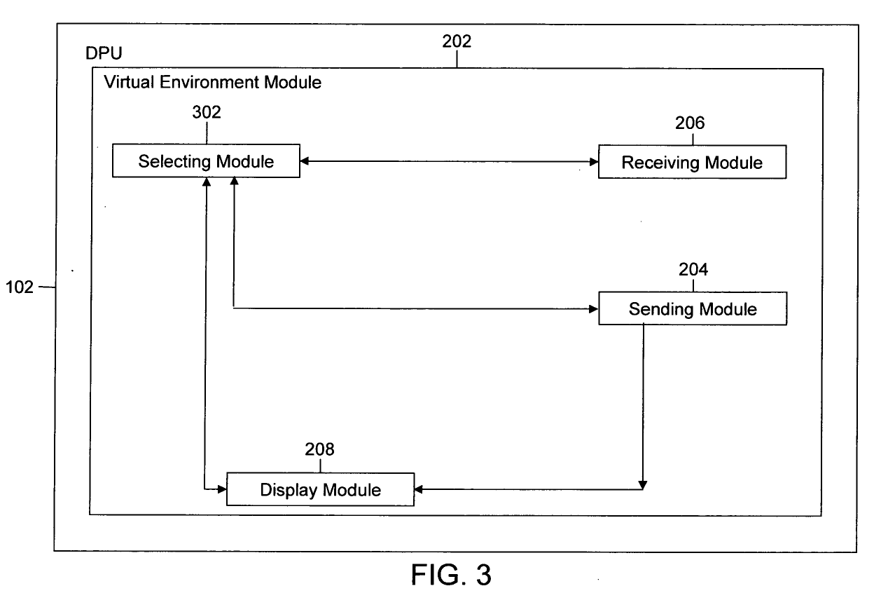

FIG. 1 illustrates an environment 100 in which various embodiments of the present invention can be practiced. Environment 100 is an interconnection of data processing units (DPUs), such as DPU 102, DPU 104, DPU 106, DPU 108, DPU 110, DPU 112 and DPU 114. A DPU is a device that can perform operations such as organization, manipulation, transformation, classification and transmission of data. Examples of DPUs include, but are not limited to, personal computers, mainframe computers, minicomputers, supercomputers, mobile telephones, microcomputers, palmtops, Personal Digital Assistant (PDAs), laptops, embedded computers, servers, and the like. DPUs are interconnected with each other through telecommunication channels. An interconnection of DPUs is referred as a network. Examples of such networks include, but are not limited to, Local Area Networks (LANs), Wide Area Networks (WANs), Metropolitan Area Networks (MANs), the Internet, and the like. The figure illustrates DPU 102 for the use of a first user, the first user being an entity practicing various embodiments of the present invention through DPU 102. DPU 102 is connected to a plurality of DPUs, including but not limited to DPU 104, DPU 106, DPU 108, DPU 110, DPU 112 and DPU 114. The plurality of DPUs can be on different networks. In an embodiment of the present invention, the first user is connected to at least one of the plurality of DPUs via a wireless network. Wireless networks follow one of several standards, including but not limited to, versions of the IEEE 802.11 specifications, versions of the IEEE 802.15.1 specifications, GSM, CDMA, IrDA link, IEEE 802.3 specifications for cabled connections, and the like. In another embodiment of the present invention, the first user is connected to at least one of the plurality of DPUs via a wired network. Each of the plurality of DPUs can be used by one or more users, hereinafter referred to as contacts. DPU 102 communicates with the plurality of DPUs by using a virtual environment module. The virtual environment module is explained in further detail with reference to FIG. 2 and FIG. 3.

FIG. 2 illustrates a block diagram of the elements of a virtual environment module 202, according to an embodiment of the present invention. Virtual environment module 202 includes a sending module 204, a receiving module 206, and a display module 208. The first user interacts with a single instance of virtual environment module 202 to communicate with one or more groups of contacts. Sending and receiving of information, are referred to as communication. Information is defined as data exchanged between the first user and one or more groups of contacts. A group of contacts may include one or more contacts. Sending module 204 accepts information from the first user and transmits it to the one or more groups of contacts. Receiving module 206 enables the first user to receive information from one or more groups of contacts. Display module 208 displays information communicated to and by the first user. In an embodiment of the present invention, display module 208 enables the first user to track information received from one or more groups of contacts by displaying the information on a display unit of DPU 102. In another embodiment of the present invention, display module 208 enables the first user to track information sent to one or more groups of contacts. In an embodiment of the present invention, display module 208 formats the displayed information. Examples of formatting include, but are not limited to, color coding, changing fonts, adding animation and time stamps, and the like. In an embodiment of the present invention, the formatting may be customized. In yet another embodiment of the present invention, separate customization of the formatting may be performed for each of the one or more groups of contacts. In an embodiment, sending module 204 transmits the information sent to the one or more groups of contacts to display module 208. In another embodiment of the present invention, receiving module 206 transmits the information received from the one or more groups of contacts to display module 208.

FIG. 3 illustrates a block diagram of the elements of virtual environment module 202 functioning within DPU 102, according to another embodiment of the present invention. As shown in FIG. 3, virtual environment module 202 includes a selecting module 302. Selecting module 302 enables the first user to select one or more groups of contacts to enable information to be sent to the selected one or more groups of contacts. In another embodiment of the present invention, selecting the one or more groups of contacts allows information to be received only from the selected one or more groups of contacts. Selecting the one or more groups of contacts and the communication with the one or more groups of contacts occur within the single instance of virtual environment module 202 on DPU 102.

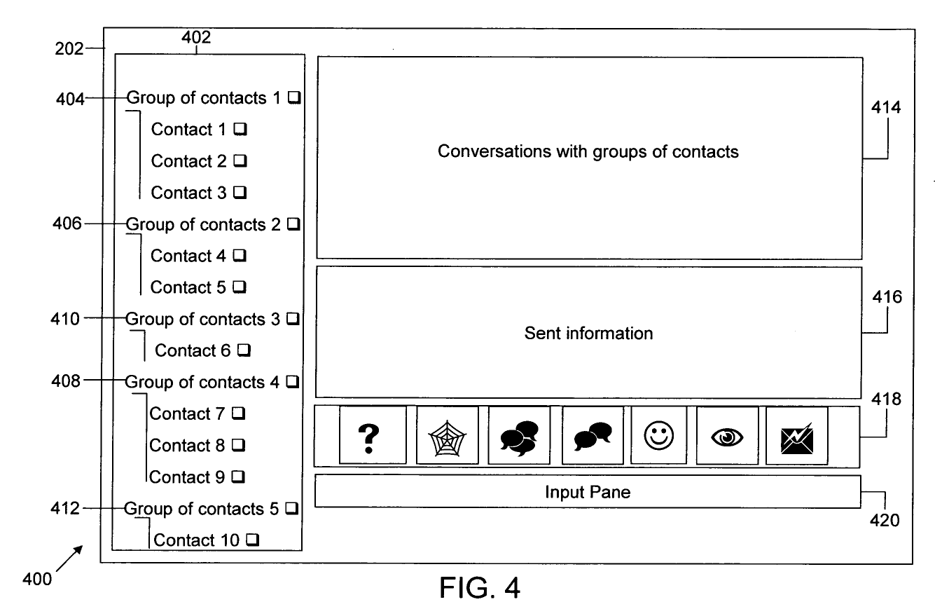

FIG. 4 illustrates interface 400 of virtual environment module 202, displayed by display module 208 to the first user, according to an embodiment of the present invention. Interface 400 includes a contact box 402, a pane 414, a pane 416, a toolbar 418 and a text input pane 420. Contact box 402 enables the first user to view all the contacts. In an embodiment of the present invention, the first user can view all the contacts in a listed form in contact box 402. The contacts are arranged in groups of contacts, including but not limited to, group of contacts 404, group of contacts 406, group of contacts 408, group of contacts 410, and group of contacts 412. Each group of contacts is visible to the first user, who can communicate with them. An ongoing communication with one or more groups of contacts is displayed in pane 414. In one embodiment of the present invention, the display module 208 formats the information displayed in pane 414. Pane 416 displays information sent by the first user to the one or more groups of contacts. In an embodiment of the present invention, display module 208 formats the information displayed in pane 416. In another embodiment of the present invention, toolbar 418 provides tools for launching an Internet browser, generating ‘emoticons’, starting multimedia conversations, stopping multimedia conversations, generating an instance of an email client to send email to the one or more groups of contacts, and the like. The toolbar 418 may also include user-defined tools. These user-defined tools perform functions defined by the first user. Input pane 420 enables the first user to input information to be sent to the one or more groups of contacts.

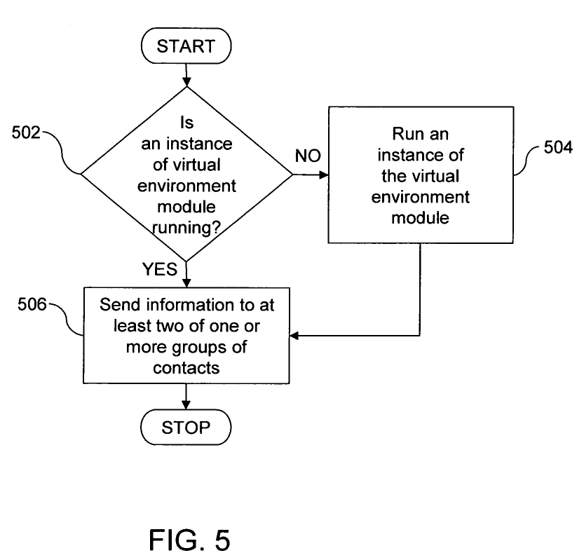

FIG. 5 illustrates a method for communication, according to an embodiment of the present invention. The method flowchart illustrates a method by which DPU 210 enables communication between the first user and the one or more groups of contacts. At step 502 it is checked if an instance of virtual environment module 202 is running. If virtual environment module 202 is not running, step 504 is executed. Step 504 enables the DPU to run virtual environment module 202. If virtual environment module 202 is running, then, at step 506, information is sent to at least two of the one or more groups of contacts via separate communication channels.

The separate communication channel ensures that the information communicated between the first user and a group of contacts is not intercepted by any other group of contacts. Further, the first user may select a list of contacts from the plurality of groups of contacts to communicate only with the selected list of contacts.

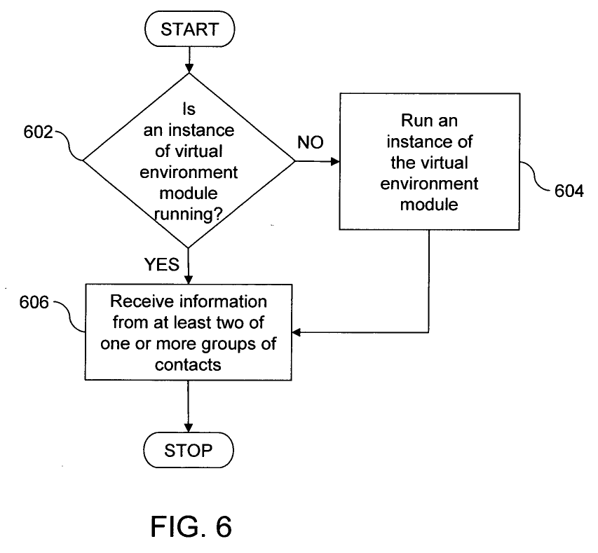

FIG. 6 illustrates a method for communication, according to another embodiment of the present invention. The method flowchart illustrates a method by which DPU 210 enables communication between the first user and the one or more groups of contacts. At step 602 it is checked if an instance of virtual environment module 202 is running. If virtual environment module 202 is not running, step 604 is executed. Step 604 enables the DPU to run virtual environment module 202. If virtual environment module 202 is running, then at step 606, information is received from at least two of the one or more groups of contacts via separate communication channels.

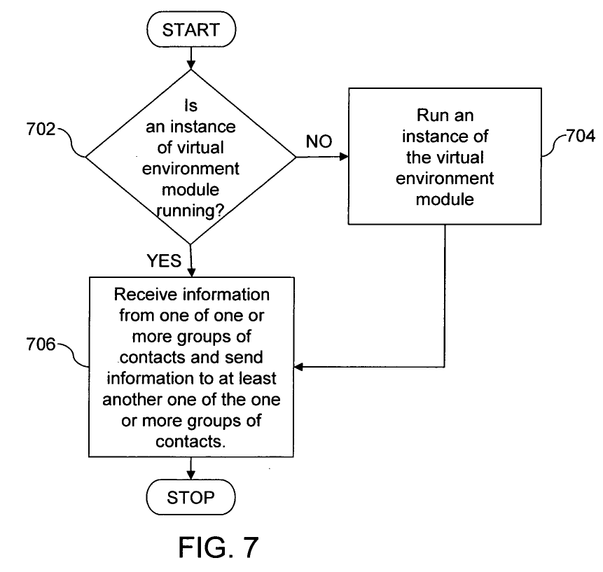

FIG. 7 illustrates a method for communication, according to yet another embodiment of the present invention. The method flowchart illustrates a method by which DPU 210 enables communication between the first user and the one or more groups of contacts. At step 702 it is checked if an instance of virtual environment module 202 is running. If virtual environment module 202 is not running, step 704 is executed. Step 704 enables the DPU to run virtual environment module 202. If virtual environment module 202 is running, then at step 706, information is received from at least one of the one or more groups of contacts, and information is sent to at least another one of the one or more groups of contacts via separate communication channels.

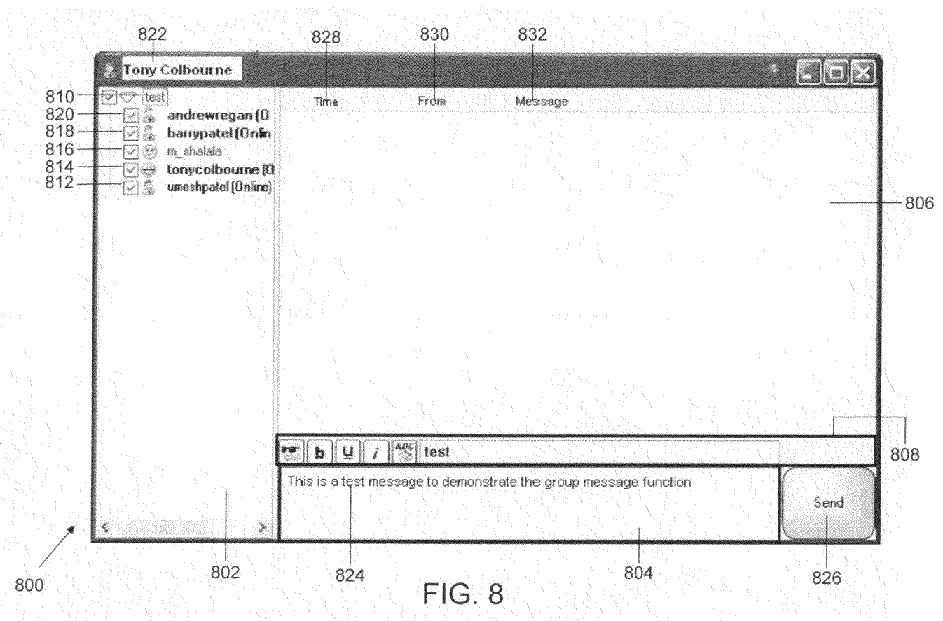

FIG. 8 to FIG. 13 illustrate various stages of communication, according to an exemplary embodiment of the invention. FIG. 8 illustrates a first stage of communication in which interface 800 is represented. Interface 800 includes a contact box 802, an input pane 804, a pane 806, a toolbar 808, a group of contacts 810, contacts 812, 814, 816, 818 and 820, a first user 822, text 824, a button 826 and fields 828, 830 and 832. Contact box 802 includes group of contacts 810, labeled as ‘test’. Contact box 802 displays contacts included in group of contacts 810. Contacts include contact 812, labeled as ‘umeshpatel’; contact 814, labeled as ‘tonycolbourne’; contact 816, labeled as ‘m_shalala’; contact 818, labeled as ‘barrypatel’; and contact 820, labeled as ‘andrewregan’. The contacts are displayed in a listed form. First user 822 is labeled as ‘Tony Colbourne’. First user 822 has entered text 824, labeled as ‘this is a test message to demonstrate the group message function’. First user 822 has entered text 824 in input pane 804. Button 826, labeled as ‘send’, enables the first user 822 to send text 824 to group of contacts 810. Pane 806 enables first user 822 to receive information. Pane 806 displays information received by first user 822 in field 828, field 830, and field 832. Field 828 displays the time at which the information is received. Field 830 displays the name of the contact from whom the information is received. Field 832 displays the text of the information received. In the present embodiment, Toolbar 808 displays one or more groups of contacts, to whom the text being entered in the input pane 804 is to be sent.

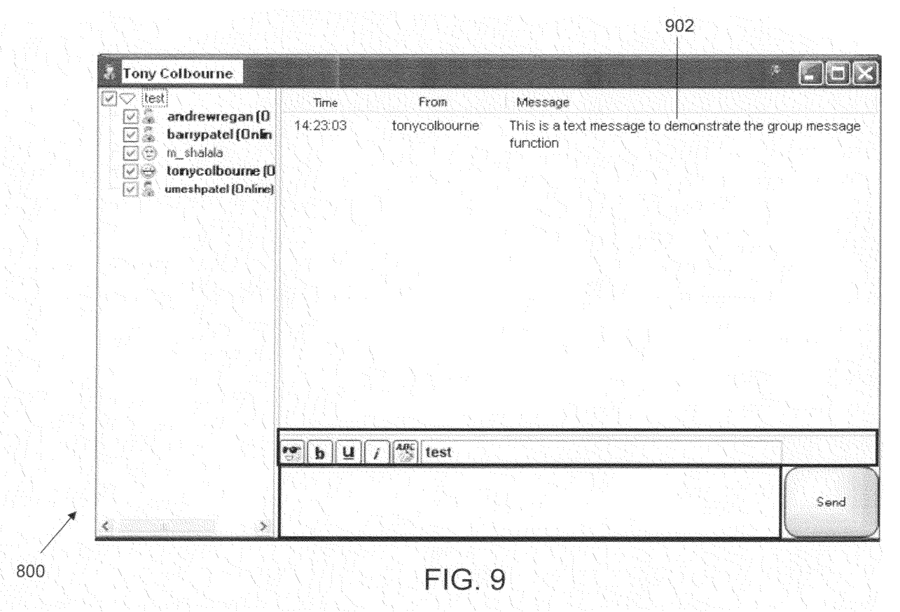

FIG. 9 illustrates a second stage of communication in which text 824 sent by first user 822 is displayed as message 902 in interface 800.

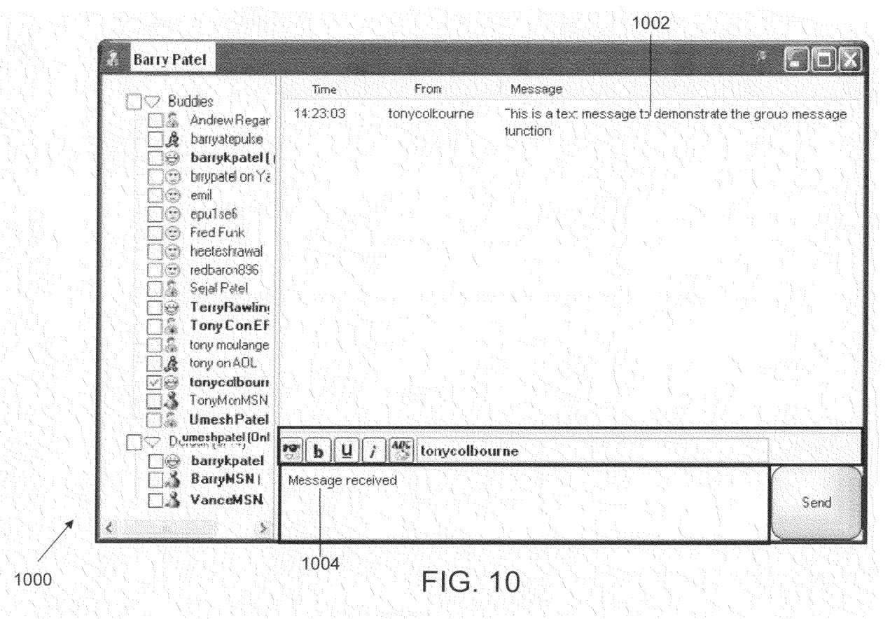

FIG. 10 illustrates a third stage of communication in which interface 1000, as viewed by contact 818, is displayed. Interface 1000 displays message 1002 received from first user 822 and also displays text 1004 contact 818 is sending to first user 822.

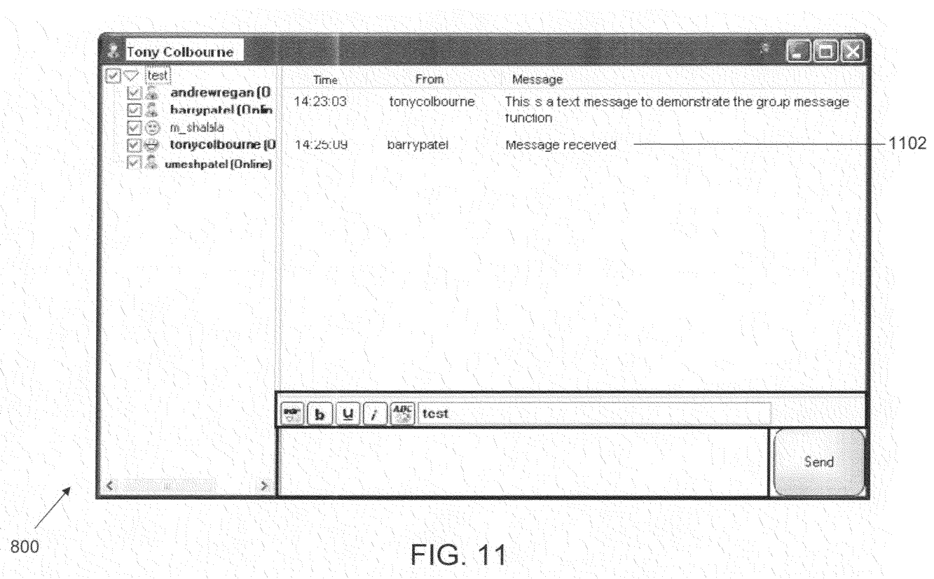

FIG. 11 illustrates a fourth stage of communication, in which text 1004 sent by contact 818 is displayed as message 1102 in interface 800.

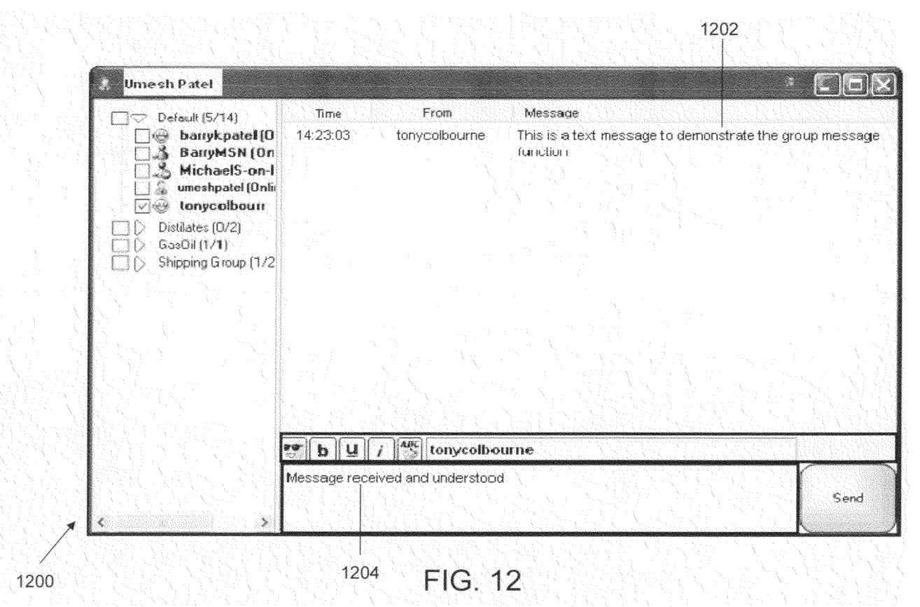

FIG. 12 illustrates a fifth stage of communication, in which interface 1200, as viewed by contact 812, is displayed. Interface 1200 displays message 1202 received from first user 822 and also displays text 1204 contact 812 is sending to first user 822.

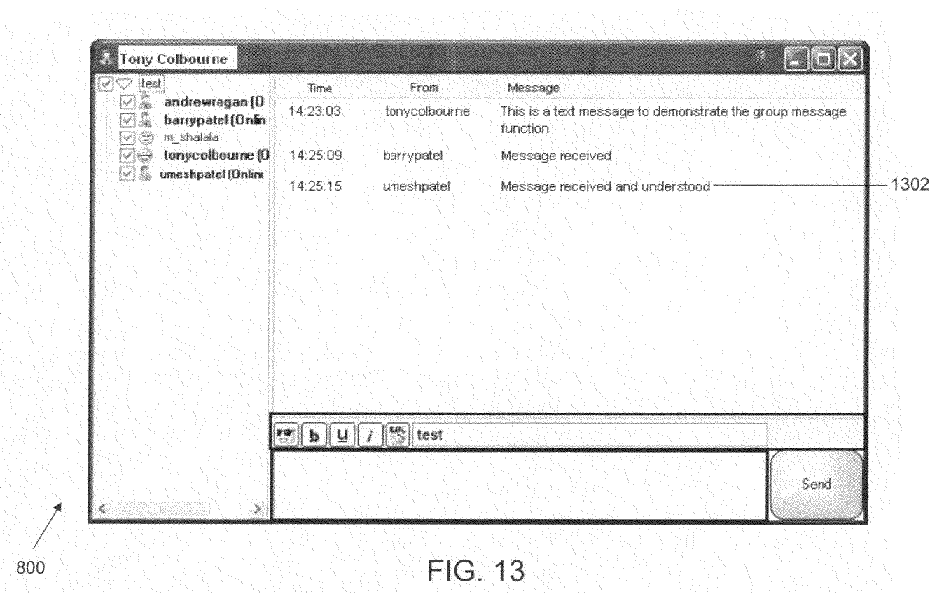

FIG. 13 illustrates a sixth stage of communication, in which text 1204 sent by contact 812 is displayed as message 1302 in interface 800.

In another embodiment of the present invention, the information sent to the one or more groups of contacts is encrypted by sending module 206, to prevent unauthorized access to the information sent. Methods of encryption known in the art, such as Rivest Shamir Adleman (RSA) encryption, Blowfish, Pretty Good Privacy (PGP), Kerberos, Secure Sockets Layer (SSL) and the like, are utilized.

In yet another embodiment of the present invention, the one or more groups of contacts use different instant messaging systems to communicate with the first user. However, the first user utilizes the present invention to communicate with the one or more groups of contacts. The instant messaging systems used to communicate, include but are not limited to, DirectNet, Internet Relay Chat (IRC), Jabber, Lotus Sametime, Mundu Speak, Protocol for Synchronous Conferencing (PSyC), Session Initiation Protocol (SIP), Simple Instant Messenger (SIMPLE), Voice-over-IP (VoIP), Instant Messaging and Presence Service (IMPS), Extensible Messaging and Presence Protocol (XMPP), NET Messenger Service, Bantu Enterprise Instant Messaging (EIM), Brosix, Open System for Communication in Realtime (OSCAR), Talk to OSCAR protocol (TOC protocol), Yahoo! Messenger Protocol (YMSG), Gadu-Gadu, Gale, Skype, and the like.

In an embodiment of the invention, the information communicated between the first user and the one or more groups of contacts includes data such as text data, audio data, video data, and combinations thereof.

In an embodiment of the present invention, the first user utilizes the invention to carry out commercial transactions with one or more groups of contacts. These commercial transactions are carried out by the first user by communicating with the one or more groups of contacts. Commercial transactions can be carried out for items including, but not limited to, financial instruments, financial services, consumer products, and the like.

The method and system of the present invention or any of its components may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. The computer also comprises a microprocessor, which is connected to a communication bus. The computer also includes a memory, which may include Random Access Memory (RAM) and Read Only Memory (ROM). Further, the computer system comprises a storage device, which can be a hard disk drive or a removable storage drive such as a floppy disk drive, optical disk drive, etc. The storage device can also be other similar means for loading computer programs or other instructions into the computer system. The computer system also includes a communication unit, which allows the computer to connect to other databases and the Internet through an I/O interface. The communication unit allows the transfer and reception of data from other databases. The communication unit may include a modem, an Ethernet card, or any similar device that enables the computer system to connect to databases and networks such as LAN, MAN, WAN, and the Internet. The computer system facilitates inputs from a user through an input device that is accessible to the system through an I/O interface.

The computer system executes a set of instructions that are stored in one or more storage elements, to process input data. The storage elements may hold data or other information, as desired, and may also be in the form of an information source or a physical memory element present in the processing machine.

The set of instructions may include various commands that instruct the processing machine to perform specific tasks such as the steps that constitute the method of the present invention. The set of instructions may be in the form of a software program. Further, the software may be in the form of a collection of separate programs, a program module with a larger program, or a portion of a program module, as in the present invention. The software may also include modular programming in the form of object-oriented programming. Processing of input data by the processing machine may be in response to user commands, the result of previous processing, or a request made by another processing machine.

While the preferred embodiments of the present invention have been illustrated and described, it will be clear that the present invention is not limited to these embodiments only. Numerous modifications, changes, variations, substitutions and equivalents will be apparent to those skilled in the art, without departing from the spirit and scope of the present invention, as described in the claims.

1. A method for enabling a first user to communicate with a plurality of groups of contacts, the first user and the plurality of groups of contacts communicating across a network of data-processing units (DPUs), the method comprising the first user performing at least one of the steps of:
a) sending information, the information being sent to at least two of the plurality of groups of contacts via separate communication channels;
b) receiving information, the information being received from at least two of the plurality of groups of contacts via separate communication channels; and
c) sending information to at least a first group of contacts and receiving information from at least a second group of contacts via separate communication channels, the first group of contacts and the second group of contacts belonging to the plurality of groups of contacts;
wherein the above steps are performed in a single instance of a virtual environment module.

2. The method according to claim 1 further comprising the step of selecting a list of contacts to communicate with the list of contacts, the list of contacts being selected from the plurality of groups of contacts.

3. The method according to claim 1 further comprising the step of color coding at least one of:
i. information received from at least one of the plurality of groups of contacts; and
ii. information sent to at least one of the plurality of groups of contacts.

4. The method according to claim 1, wherein the communication with the plurality of groups of contacts is achieved using a plurality of messaging protocols.

5. The method according to claim 1 further comprising the step of encrypting the information to prevent access to the information by an unauthorized user.

6. The method according to claim 1, wherein the communication is real-time-communication.

7. A method for enabling a first user to communicate with a plurality of groups of contacts, the first user and the plurality of groups of contacts communicating across a network of data-processing units (DPUs), the method comprising the step of sending information, the information being sent to at least two of the plurality of groups of contacts via separate communication channels, wherein the first user performs the above step in a single instance of a virtual environment module.

8. The method according to claim 7 further comprising the step of selecting a list of contacts, to send information to the list of contacts, the list of contacts being selected from the plurality of groups of contacts.

9. The method according to claim 7 further comprising the step of color coding information sent to at least one of the plurality of groups of contacts.

10. The method according to claim 7, wherein the step of sending information to the plurality of groups of contacts is achieved using a plurality of messaging protocols.

11. The method according to claim 7 further comprising the step of encrypting the information to prevent access to the information by an unauthorized user.

12. The method according to claim 7, wherein the communication is real-time-communication.

13. A method for enabling a first user to communicate with a plurality of groups of contacts, the first user and the plurality of groups of contacts communicating across a network of DPUs, the method comprising the step of receiving information, the information being received from at least two of the plurality of groups of contacts via separate communication channels, wherein the first user performs the above step in a single instance of a virtual environment module.

14. The method according to claim 13 further comprising the step of selecting a list of contacts to receive information from the list of contacts, the list of contacts being selected from the plurality of groups of contacts.

15. The method according to claim 13 further comprising the step of color coding information received from at least one of the plurality of groups of contacts.

16. The method according to claim 13, wherein the step of receiving information from the plurality of groups of contacts is achieved using a plurality of messaging protocols.

17. The method according to claim 13 further comprising the step of encrypting the information to prevent access to the information by an unauthorized user.

18. The method according to claim 13, wherein the communication is real-time-communication.

19. A method for enabling a first user to communicate with a plurality of groups of contacts, the first user and the plurality of groups of contacts communicating across a network of data-processing units (DPUs), the method comprising the first user performing the steps of:
a) sending information to at least a first group of contacts; and
b) receiving information from at least a second group of contacts;
wherein, the first group of contacts and the second group of contacts belong to the plurality of groups of contacts, wherein the above steps are performed via separate communication channels and in a single instance of a virtual environment module.

20. The method according to claim 19 further comprising the step of selecting a list of contacts to communicate with the list of contacts, the list of contacts being selected from the plurality of groups of contacts.

21. The method according to claim 19 further comprising the step of color coding at least one of:
a) information received from at least one of the plurality of groups of contacts; and
b) information sent to at least one of the plurality of groups of contacts.

22. The method according to claim 19, wherein the communication with the plurality of groups of contacts is achieved using a plurality of messaging protocols.

23. The method according to claim 19 further comprising the step of encrypting the information to prevent access to the information by an unauthorized user.

24. The method according to claim 19, wherein the communication is real-time-communication.

25. A method for enabling a first user to communicate with a plurality of groups of contacts, the first user and the plurality of groups of contacts communicating across a network of data-processing units (DPUs), the plurality of groups of contacts being connected to the first user via a plurality of messaging protocols, the method comprising:
a) selecting a first plurality of groups of contacts from the plurality of groups of contacts; and
b) performing at least one of the steps of:
i. sending information, the information being sent to each of the first plurality of groups of contacts via separate communication channels;
ii. receiving information, the information being received from at least two of the first plurality of groups of contacts via separate communication channels; and
iii. sending information to the first plurality of groups of contacts and receiving information from at least a group of contacts belonging to the first plurality of groups of contacts, via separate communication channels;
wherein the first user performs the above steps in a single instance of a virtual environment module.

26. A system for enabling communication between a first user and a plurality of groups of contacts, the first user communicating with each of the plurality of groups of contacts via a network of data-processing units (DPUs), the system comprising a virtual environment module, the virtual environment module comprising:
a) an information sending module, the information sending module sending information to at least one of the plurality of groups of contacts;
b) an information receiving module, the information receiving module receiving information from at least one of the plurality of groups of contacts; and
c) a display module, the display module performing a task of displaying in a single instance of the virtual environment module, at least one of:
i. information sent to at least two of the plurality of groups of contacts;
ii. information received from at least two of the plurality of groups of contacts; and
iii. information sent to at least one of the plurality of groups of contacts and information received from at least one of the plurality of groups of contacts;
wherein the communication between the first user and each of the plurality of groups of contacts is accomplished via separate communication channels.

27. The system according to claim 26, wherein the display module displays information corresponding to at least one of the plurality of groups of contacts using customized colors.

28. The system according to claim 26 further comprising a selecting module, the selecting module enabling the first user to select at least one of the plurality of groups of contacts.

29. A computer program product for use with a computer, the computer program product comprising a computer usable medium having a computer readable program code embodied therein for enabling a first user to communicate with a plurality of groups of contacts, the first user and the plurality of groups of contacts communicating across a network of data-processing units (DPUs), the computer program code enabling at least one of the steps of:
a) sending information, the information being sent to at least two of the plurality of groups of contacts via separate communication channels;
b) receiving information, the information being received from at least two of the plurality of groups of contacts via separate communication channels; and
c) sending information to at least a first group of contacts and receiving information from at least a second group of contacts via separate communication channels, the first group of contacts and the second group of contacts belonging to the plurality of groups of contacts;
wherein the first user performs the above steps in a single instance of a virtual environment module.
